(19) United States
(12) Patent Application Publication
(10) Pub. No.: US 2009/0115243 A1
(43) Pub. Date: May 7, 2009

(54) Method for Regulating The Pressure In An Electronically Controlled Brake System, and Electronic Brake System

(75) Inventors: Jurgen Woywod, Morfelden (DE); Michael Meixner, Frankfurt (DE); Rene Zysno, Frankfurt (DE)

Correspondence Address: RATNERPRESTIA, P.O. BOX 980, VALLEY FORGE, PA, 19482, US

(73) Assignee: Continental Teves AG & Co. oHG, Frankfurt (DE)

(21) Appl. No.: 12/296,153

(22) PCT Filed: Mar. 23, 2007
(86) PCT No.: PCT/EP07/52817

§ 371 Date: Oct. 6, 2008

(30) Foreign Application Priority Data
Apr. 11, 2006 (DE) 10 2006 017 357.0

(51) Int. Cl. B60T 8/17; B60T 8/32

(52) U.S. Cl. 303/35

(57) ABSTRACT

A method for regulating the brake pressure in an electronically controlled brake system for a motor vehicle. According to the method, an activation event results in an active pressure increase in a brake circuit. The activation event may result in no active pressure increase in a brake circuit in certain situations in which the braking effect of the active pressure increase is not required. Also disclosed is an electronic brake system.

### CROSS-REFERENCE TO RELATED APPLICATIONS

This application is the U.S. national phase application of PCT International Application No. PCT/EP2007/052817 filed Mar. 23, 2007, which claims priority to German Patent Application No. DE102006017357.0, filed Apr. 11, 2006, the contents of such applications being incorporated by reference herein in their entirety.

### BACKGROUND OF THE INVENTION

1. Field of the Invention

The invention relates to a method for regulating the pressure in an electronically controlled brake system, and electronic brake system.

2. Description of the Related Art

In the course of the last few decades, the motorcycle has developed from a cost-effective means of locomotion into a recreational vehicle in which emphasis is increasingly placed on the driver's safety and comfort.

Similarly to motor vehicles several years ago, motorcycles are also being increasingly equipped with antilock brake systems (ABS). EP 0 548 985 B1 discloses, for example, an antilock brake device for motorcycles. In addition, DE 40 00 212 A1 discloses a method for braking a motorcycle with antilock protection and for determining the coefficient of adhesion.

Motorcycles have traditionally had one operating element for each of the two brake circuits. The front wheel brake is usually activated by means of a “handbrake lever”, and the rear brake lever activated by means of a “foot brake lever”.

In the context of motorcycles, an “integral brake system” is understood to be a brake system in which when the handbrake lever or the footbrake lever is activated the brake of the second brake circuit is additionally applied by means of an active pressure increase. By operating a single operating element it is therefore possible to actuate both brakes. If both brakes are respectively actuated when the handbrake lever and the footbrake lever are activated, this is referred to as a fully integral brake. However, combinations are possible in which one brake lever acts on one wheel and the other brake lever acts on both wheels (partially integral brake). Integral brake systems for motorcycles are known, for example, from DE 38 03 563 A1 and DE 103 16 351 A1.

Owing to the increased safety and/or the increased comfort it is to be expected that in future partially integral brakes and fully integral brakes will be used to an ever increasing degree in motorcycles and they will assist the driver in carrying out the braking process and therefore ensure an optimized braking distance through an active pressure increase at the front and/or rear wheel.

An active increase in brake pressure is always accompanied by a certain amount of noise and by wear. For an active pressure increase, valves and a pump of the electronic brake system (EBS) are required and they generate a considerable amount of noise. Particularly in the stationary state with the engine switched off or idling, the noise is completely audible to the driver and can be disruptive.

The invention relates to a method for regulating the brake pressure in an electronically controlled brake system, in particular in an integral brake system for a motorcycle, and an electronic brake system, in particular an integral brake system for a motorcycle, which generates as little noise as possible and in which the wear of the components is as low as possible.

The invention also relates to the idea of avoiding an active pressure increase in a brake circuit if it is not necessary.

Pressure increases is to be understood as the plural of pressure increase.

It is preferred if an active increase in brake pressure is not necessary in a brake circuit if the vehicle, in particular the motorcycle, is stationary or is moving at a very low velocity since in this case an increased braking effect is not required.

The invention preferably relates to a method for regulating the brake pressure in an integral brake system for a motorcycle. In this context the integral brake system comprises at least one pump for actively increasing brake pressure at at least one wheel brake.

The activation event is preferably an operation of a brake operating element of a motorcycle with which a front wheel brake and a rear wheel brake are actuated. According to the prior art, when a brake operating element which is equipped with an integral function is activated, an active pressure increase is always implemented in the other wheel brake circuit which is not directly assigned to the operating element. According to aspects of the invention this is prevented if the braking effect is not required.

According to one preferred embodiment of the method according to aspects of the invention it is detected that the vehicle is stationary or approximately stationary if a variable which is a measure of the velocity of the vehicle or of a wheel speed drops below a predefined limiting value. By suitably selecting the limiting value, a variable detection of the stationary state or “almost stationary state detection” is possible. The limiting value is particularly preferably selected as a function of the type and/or the model of the vehicle. Vehicle-specific adaptation of the method according to aspects of the invention is therefore possible. Likewise, it is preferred to select the limiting value additionally or alternatively in accordance with a driver's request. Adaptation of the method according to aspects of the invention to the driving behavior, the driving habits and/or the driving preferences of the individual driver is therefore achieved.

A wheel speed signal from a front wheel or from a rear wheel is preferably used to determine whether the vehicle is stationary or approximately stationary. The wheel speed signal is usually available within the scope of an antilock brake system in the motor vehicle and can easily be utilized for the method according to aspects of the invention. The detection of the stationary state or “almost stationary state detection” is particularly preferably carried out by means of one wheel speed signal from a front wheel and one from a rear wheel. Reliable detection is therefore possible.

The stationary state or approximately stationary state of the vehicle is advantageously detected if the number of signal edges of at least one wheel signal is lower than a predefined threshold value for a predefined time interval. This permits sensitive detection of movement.

The brake system according to aspects the invention also preferably comprises a front wheel brake and rear wheel brake as well as at least one operating element with which the front wheel brake and the rear wheel brake can be actuated simultaneously.

It is also preferred that the integral brake system comprises an electronic regulating device for regulating the brake pressures at the front wheel brake and at the rear wheel brake.

Furthermore, the integral brake system preferably comprises wheel speed sensors for measuring the wheel speeds of the front wheel and/or of the rear wheel, with the wheel speed sensors being connected to the regulating device.

A first preferred embodiment of the brake system according to aspects of the invention is an integral brake with a first brake operating element for activating a first master brake cylinder which is connected via a hydraulic brake pressure-regulating device to a first wheel brake which is arranged either at the front wheel or at the rear wheel, and with a second wheel brake which is arranged at that front wheel or rear wheel which does not have the first wheel brake, in which case the first and second wheel brake can be actuated simultaneously by operating the first brake operating element. When the first brake operating element is activated, a pump and a suitable connection of the valves of the brake system bring about an active pressure increase at the second wheel brake.

According to a second preferred embodiment of the brake system according to aspects of the invention, the integral brake comprises, in addition to the components of the first preferred embodiment, a second brake lever for activating a second master brake cylinder, which brake lever is connected via a second hydraulic brake pressure-regulating device to the second wheel brake. By operating the second brake operating element, the first and second wheel brakes (fully integral brake) are actuated simultaneously or only the second wheel brake (partial integral brake) is actuated.

An advantage of the invention is that through sensitive detection of movement it is possible to decide whether or not the motorcycle is moving, and consequently it is possible to make a decision as to whether or not an active pressure increase for assisting the driver is necessary.

A further advantage is avoiding the generation of noise by the electronic brake system. It is even possible that in stationary state situations the electronic brake system according to aspects of the invention will no longer be perceived. The material wear in the electronic brake system is likewise advantageously reduced according to aspects of the invention without having to accept a functional disadvantage as the cost.

These and other aspects of the invention are illustrated in detail by way of the embodiments and are described with respect to the embodiments in the following, making reference to the Figures.

### BRIEF DESCRIPTION OF THE DRAWINGS

The aspects of is best understood from the following detailed description when read in connection with the accompanying drawing. Included in the drawing are the following figures:

FIG. 1 is a schematic view of an exemplary partial integral brake system of a motorcycle for carrying out a method according to aspects of the invention, and

FIG. 2 is a schematic illustration of a motorcycle.

### DETAILED DESCRIPTION OF THE PREFERRED EMBODIMENTS

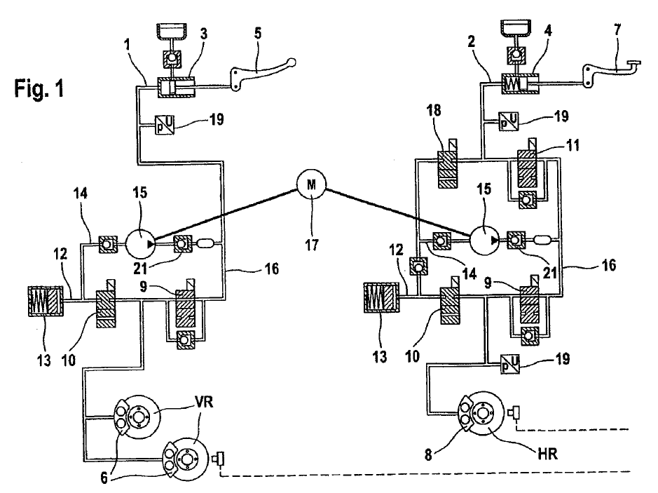

The method according to aspects of the invention is described below on the basis of a motorcycle brake system with partial integral braking function (see FIG. 1) but it can also be carried out in any other brake system in which an active increase in brake pressure is carried out when an activation event occurs. For example, the method can be carried out in a fully integral brake system of a motorcycle or in a passenger car brake system.

FIG. 1 is a schematic illustration of an exemplary partially integral brake system for a motorcycle. Said partially integral brake system is composed of two brake circuits 1, 2, one for the front wheel FW and one for the rear wheel RW, each with a master brake cylinder 3, 4. The driver directly activates the front wheel brake 6 with a handbrake lever 5, and the rear wheel brake 8 is activated with a foot pedal 7.

In order to regulate brake slip, inlet valve 9 and outlet valve 10 which can be activated electromagnetically are arranged both in the front wheel brake circuit 1 and in the rear wheel brake circuit 2, and in each case in this context an inlet valve 9 which is opened in the home position is inserted into the brake line of the front wheel brake circuit 1 and into that of the rear wheel brake circuit 2, which connects the respectively associated master brake cylinders 3, 4 to the front wheel brake 6 or rear wheel brake 8. In the rear wheel brake 2 there is additionally an isolating valve 11 which is opened in the home position. The outlet valve 10 which is closed in the home position is inserted in each case into a return flow line 12 of each brake circuit, which return flow line 12 connects the front wheel brake 6 or rear wheel brake 8 to, in each case, a low pressure accumulator 13 and the suction path 14 of a pump 15 which is divided into two circuits and which operates according to the feedback principle. The pump 15 is connected on the pressure side to the brake lines 16 of the two brake circuits so that in a brake slip regulating phase it is ensured that the brake fluid volume which is respectively discharged by the front wheel brake 6 or rear wheel brake 8 is fed back according to demand into the brake lines 16 of the two brake circuits. The pump pistons of the two pump circuits are driven in common by an electric motor 17.

The two brake circuits 1, 2 are, in accordance with their circuit design, capable of being activated in common or independently of one another, with the particular feature that in the case of manual activation of the master brake cylinder 3 which is connected to the front wheel brake circuit 1 not only is brake pressure increased in the front wheel brake 6 but at the same time also brake pressure is increased electro-hydraulically (active pressure increase) in the rear wheel brake 8 by virtue of the fact that the electric motor 17 activates the pump 15 as soon as the pump 15 extracts pressure medium from the master brake cylinder 4 and feeds it to the rear wheel brake 8 owing to the open position of the changeover valve 18 which is initiated electrically in the rear wheel brake circuit 2, while the isolating valve 11 in the rear wheel brake circuit 2 isolates the pump pressure side from the master brake cylinder 4.

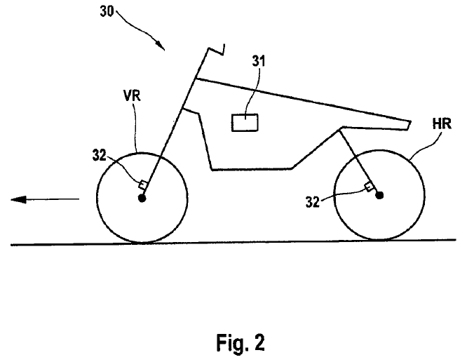

FIG. 2 is a schematic illustration of a motorcycle. A motorcycle 30 with a control unit 31 and a wheel speed sensor 32 on the front wheel FW and one on the rear wheel RW moves in the direction specified by the arrow. The control unit 31 is configured, for example, to control the brake pressure regulating operations for the purpose of antilock brake control and/or the integral brake function.

An active increase in brake pressure is always accompanied by noise and wear. The valves 11, 18 and the pump 15 of the electronic system are required for the active pressure increase and therefore generate a considerable amount of noise. Particularly in the stationary state with the engine switched off or idling, the noise is completely audible to the driver and can be disruptive.

Since in the exemplary integral brake system (FIG. 1), an active pressure increase, which is not directly assigned to the activated brake lever 5, takes place in the rear wheel brake circuit 2 whenever the handbrake lever 5 is activated by the driver, according to aspects of the invention, and also in view of the material wear, only pressure increases which are actually necessary to achieve the braking effect are carried out.

According to aspects of the invention, unnecessary pressure increases are therefore avoided for the sake of the problems of generation of noise and of wear which are described above. Therefore, inter alia, pressure increases are not necessary while the motorcycle 30 is in the stationary state, since no braking effect is required in the stationary state.

It is then necessary to determine whether or not the motorcycle 30 is in the stationary state, in order to avoid a possibly unnecessary pressure increase. In order to detect whether the motorcycle 30 is moving (and as a result not in the stationary state), for example the wheel signals of the wheel speed sensors 32 of the front wheel FW and of the rear wheel RW are analyzed. The number of incoming wheel signals (ticks) per calculation cycle (loop) are placed in relationship with the time which has passed. If sufficient ticks are counted in a specific time window, the motorcycle 30 is considered to be in the non-stationary state. If fewer than required or no ticks are counted, the motorcycle 30 is by definition in the stationary state. It is possible, for example, to select a velocity of the vehicle of 2 km/h or lower as a limiting value at and below which the motorcycle 30 is by definition considered as being in the stationary state, or a corresponding wheel speed or a corresponding number of incoming wheel signals (ticks) per calculation cycle (loop) can be selected.

If the motorcycle 30 is in the stationary state, the brake pressure is only managed “passively”. This means, for example, that the activation of the pump 15 and electric changeover valve 18 (ECV) is prevented for actively increasing brake pressure in the rear wheel brake circuit 2. For example, only the pressure which is still available in the brake circuit 2 is still managed. It is therefore only possible then to maintain or reduce brake pressure in accordance with the driver's request. Furthermore, it is in addition important to increase the pressure in the brake circuit 2 manually by operating the foot brake pedal 7. This manually increased pressure can then also be managed passively by the electronic brake system, as described above.

If a movement of the motorcycle 30 is detected through the summing of sufficient ticks of the wheel speed signals of a wheel speed sensor 32 in the requested time window, the passive mode is exited and the electronic brake system can again actively increase brake pressure at the rear wheel RW (in accordance with the driver's request). By suitably selecting the number of required ticks and the time window, movement can be detected as sensitively as desired. This ensures that even very small movements of the motorcycle 30 (given a corresponding driver's request) result in active pressure increases which are suitable for directly bringing the vehicle to a standstill again.

Specifically in situations in which the motorcycle 30 is to be held or maneuvered on steep inclines, an optimum braking effect can therefore be achieved at the rear wheel RW. This is particularly significant in that particularly in such situations the greatest braking effect can be achieved with the rear wheel RW.

As a result of the described measures, the generation of noise by the electronic brake system is considerably reduced and can even no longer be perceived in the described stationary state situations. Likewise, the material wear in the electronic brake system is reduced without a functional disadvantage having to be accepted as the cost.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

1.-8. (canceled)

9. A method for regulating the brake pressure in an electronically controlled brake system of a motor vehicle, said method comprising the steps of:
performing an activation event;
detecting an operating state of the vehicle; and
actively increasing pressure in a brake circuit of the electronically controlled brake system of the motor vehicle in response to the activation event so as to produce a braking effect,
wherein the step of actively increasing pressure is carried out as a function of the operating state of the vehicle.

10. The method as claimed in claim 9, wherein the step of performing an activation event comprises operating a brake operating element of the motor vehicle.

11. The method as claimed in claim 9, wherein the step of performing an activation event comprises operating a brake operating element of a motorcycle to actuate a front wheel brake and a rear wheel brake of the motorcycle.

12. The method as claimed in claim 9, wherein the step of actively increasing pressure is not carried out when the detecting step indicates that the vehicle is either stationary or approximately stationary.

13. The method as claimed in claim 12, wherein the detecting step further comprises comparing a pre-defined limiting value with a variable that is a measure of either a velocity of the vehicle or wheel speed, wherein when the variable is less than the pre-defined limiting value the detecting step indicates that the vehicle is either stationary or approximately stationary.

14. The method as claimed in claim 13, wherein the detecting step comprises comparing a wheel speed signal from a wheel of the motor vehicle with the pre-defined limiting value to determine whether the vehicle is stationary or approximately stationary.

15. The method as claimed in claim 13, wherein the detecting step comprises comparing a wheel speed signal from a front wheel and a rear wheel of the motor vehicle with the pre-defined limiting value to determine whether the vehicle is either stationary or approximately stationary.

16. The method as claimed in claim 14, wherein the detecting step comprises comparing the number of signal edges of at least one wheel speed signal with a pre-defined threshold value, wherein when the number of signal edges is lower than the pre-defined threshold value for a predefined time interval the vehicle is either stationary or approximately stationary.

17. An electronic integral brake system for a motorcycle, in which a method as claimed in claim 9 is carried out.
